(19) United States
(12) Patent Application Publication
(10) Pub. No.: US 2023/0219186 A1
(43) Pub. Date: Jul. 13, 2023

(54) PORTABLE GRINDING TOOL AND CASING STRUCTURE THEREOF

(71) Applicant: BASSO INDUSTRY CORP., Taichung (TW)

(72) Inventors: Ta-Chieh LIN, Taichung (TW); San-Yih SU, Taichung (TW)

(73) Assignee: BASSO INDUSTRY CORP., Taichung (TW)

(21) Appl. No.: 18/095,034

(22) Filed: Jan. 10, 2023

(30) Foreign Application Priority Data
Jan. 11, 2022 (TW) 111200375

(51) Int. Cl. B24B 23/02; B25F 5/02

(52) U.S. Cl. CPC B24B 23/028; B25F 5/02

(57) ABSTRACT

A portable grinding tool includes a casing structure and a drive unit. The casing structure includes a main body part defining a first axis, and a grip part extending from the main body part along a second axis. The drive unit is mounted to the main body part and includes a rotating shaft for outputting rotational kinetic energy, the rotating shaft has an output section that extends along the first axis and passes out through the main body part. The output section and the grip part cooperate to define an angle included therebetween and ranging between 95 and 135 degrees.

### CROSS-REFERENCE TO RELATED APPLICATION

This application claims priority to Taiwanese Invention Patent Application No. 111200375, filed on Jan. 11, 2022.

### FIELD

The disclosure relates to a portable power tool, more particularly to a portable grinding tool and a casing structure thereof.

### BACKGROUND

Referring to FIG. 1, a direct-drive grinding tool 1, typically of the type similar to that described in U.S. Pat. No. 10,730,175, has a casing 11, a drive unit 12, a battery unit 13, and a trigger unit 14. The casing 11 includes a main body part 111 extending along a first axis (R1), and a grip part 112 extending from the main body part 111 along a second axis (R2) perpendicular to the first axis (R1). The drive unit 12 is installed on the main body part 111 and includes a rotating shaft 121 for outputting rotational kinetic energy, a motor 122 for directly driving the rotating shaft 121 to rotate, and a grinding piece 123 detachably mounted on the rotating shaft 121. The battery unit 13 for providing electrical energy to the motor 122 is installed in the grip part 112. The trigger unit 14 is mounted on the grip part 112 and is operable for triggering rotation of the rotating shaft 121. As a result, the rotating shaft 121 drives the grinding tool piece 123 to rotate, allowing it to grind an object 2.

However, since the grip part 112 and the rotating shaft 121 are at a right angle to each other, when the grinding tool 1 is operated on a working surface that is a stepped surface as illustrated by the phantom lines in FIG. 1, a user’s hand holding the grip part 112 is close to a higher step of the stepped surface while the grinding tool piece 123 is working on an immediate lower step, which is unfavorable for operation of the trigger unit 14. Especially when there are obstacles, the trigger unit 14 is prone to false triggering due to accidental collision, increasing the risk of accident. It is noted that the industry may adopt a design where the length of the rotating shaft 121 is increased to alleviate the problems caused by insufficient operating space as mentioned above. However, this design will make the casing 11 farther from the working surface, resulting in troublesome operation and control.

Moreover, when using the grinding tool 1, the user needs to expend substantial holding effort to keep the grinding tool 1 steady because the casing 11 is subject to the torque of a reaction force from the rotating shaft 121. As a result, using one hand to operate the grinding tool 1 is challenging, and the grinding tool 1 is also susceptible to shaking vibration during use.

Additionally, when the battery unit 13 is installed in the grip part 112, the grinding tool 1 has a center of gravity located away from the casing 111. Therefore, it is strenuous for the user to bring the grinding tool piece 123 closer to the object 2 to be ground when the grinding tool 1 is handled from the grip part 112. The grinding tool 1 thus has the drawback of causing the user to be fatigued.

### SUMMARY

Therefore, an object of the disclosure is to provide a grinding tool and casing structure thereof that can alleviate at least one of the drawbacks of the prior art.

According to the disclosure, the portable grinding tool includes a casing structure and a drive unit. The casing structure includes a main body part defining a first axis, and a grip part extending from the main body part along a second axis. The drive unit is mounted on the main body part and includes a rotating shaft and a brushless motor. The brushless motor drives the rotating shaft to output rotational kinetic energy. The rotating shaft has an output section extending along the first axis and passing out through the main body part. The output section and the grip part cooperate to define an angle included therebetween and ranging between 95 and 135 degrees.

According to the disclosure, a casing structure of a portable grinding tool includes a main body part and a grip part. The portable grinding tool includes a rotating shaft adapted for outputting rotational kinetic energy and extending along a first axis. The main body part is configured for rotatable mounting of the rotating shaft thereon. The grip part extends from the main body part along a second axis at an angle ranging between 95 and 135 degrees with respect to the first axis.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view of a conventional grinding tool;

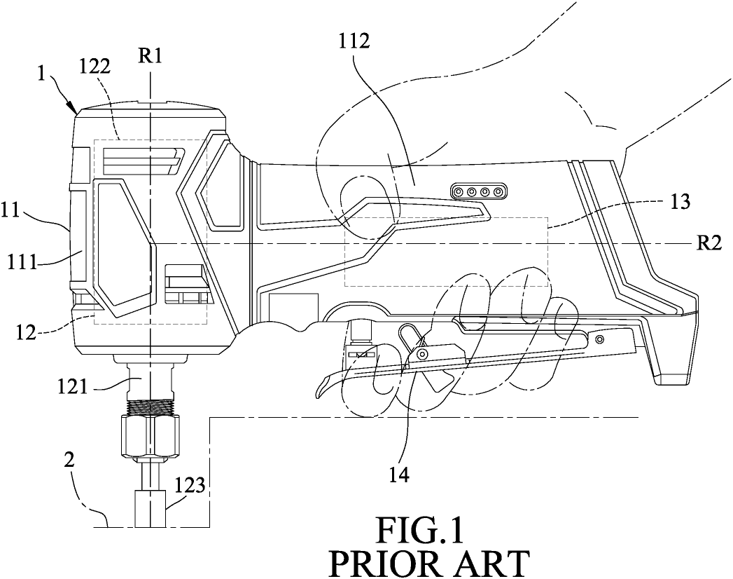

FIG. 2 is a schematic view illustrating an embodiment of a portable grinding tool according to the disclosure;

FIG. 3 is a cross-sectional view of the embodiment; and

FIG. 4 is a schematic view illustrating the embodiment of the portable grinding tool that is used to grind an object.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

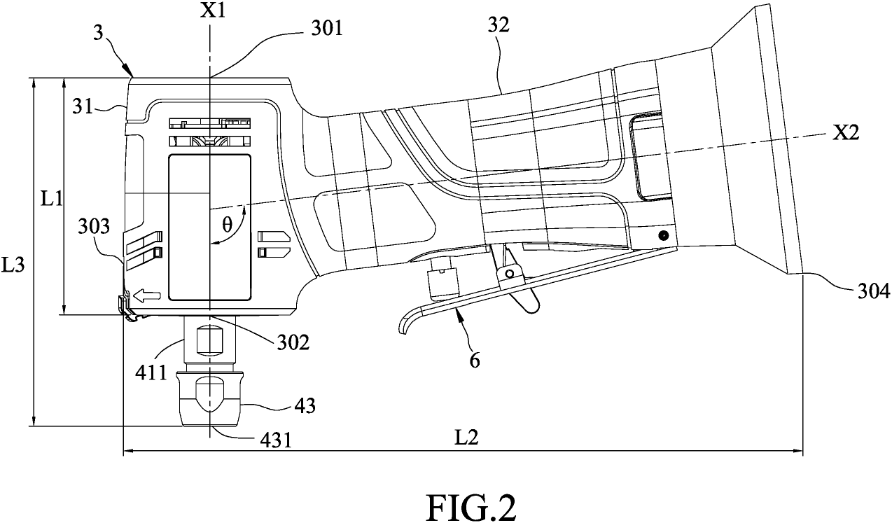

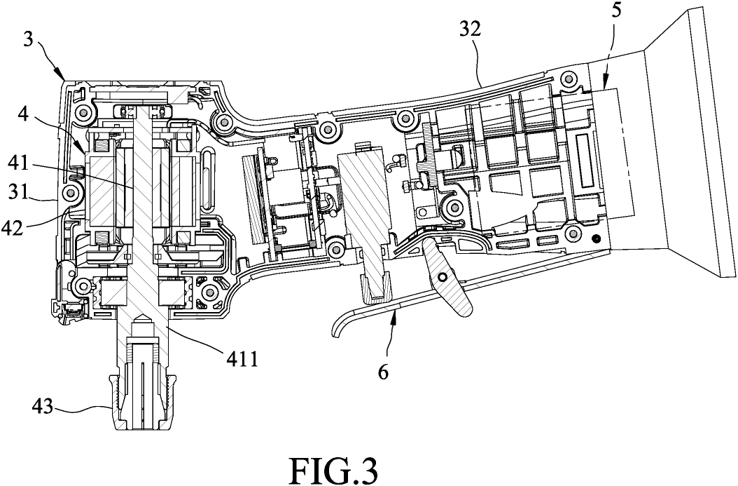

Referring to FIGS. 2 and 3, an embodiment of a portable grinding tool according to the present disclosure includes a casing structure 3, a drive unit 4, a battery unit 5, and a trigger unit 6.

The casing structure 3 includes a main body part 31 defining a first axis (X1) and a grip part 32 extending from the main body part 31 along a second axis (X2).

In this embodiment, the main body part 31 extends along the first axis (X1). The main body part 31 has a first side 301, a second side 302 distal from the first side 301 along the first axis (X1), and a third side 303 distal from the grip part 32 along the second axis (X2). The first side 301 is spaced apart from the second side 302 along the first axis (X1) by a first distance L1(X1), which is less than 75 millimeters (mm), preferably 74 mm.

The grip part 32 has a fourth side 304 distal from the third side 303 of the main body part 31 along the second axis (X2). Projections of the third side 303 and the fourth side 304 onto a plane perpendicular to the first axis (X1) are spaced apart from each other by a second distance L2, which ranges between 200 mm and 240 mm, and is preferably 230 mm or 208 mm.

The drive unit 4 is mounted on the main body part 31. The drive unit 4 includes a rotating shaft 41 for outputting rotational kinetic energy, a brushless motor 42 that is electrically powered to directly drive the rotating shaft 41 to rotate, and a working chuck 43. The main body part 31 is configured for rotatable mounting of the rotating shaft 41 thereon.

The rotating shaft 41 has an output section 411 that passes through and out of the main body part 31 and extends along the first axis (X1). An angle (θ) between the second axis (X2) and the first axis (X1) is equivalent to the angle (θ) formed between the grip part 32 and the output section 411. The angle (θ) ranges between 95 and 135 degrees, and is preferably between 95 and 100 degrees.

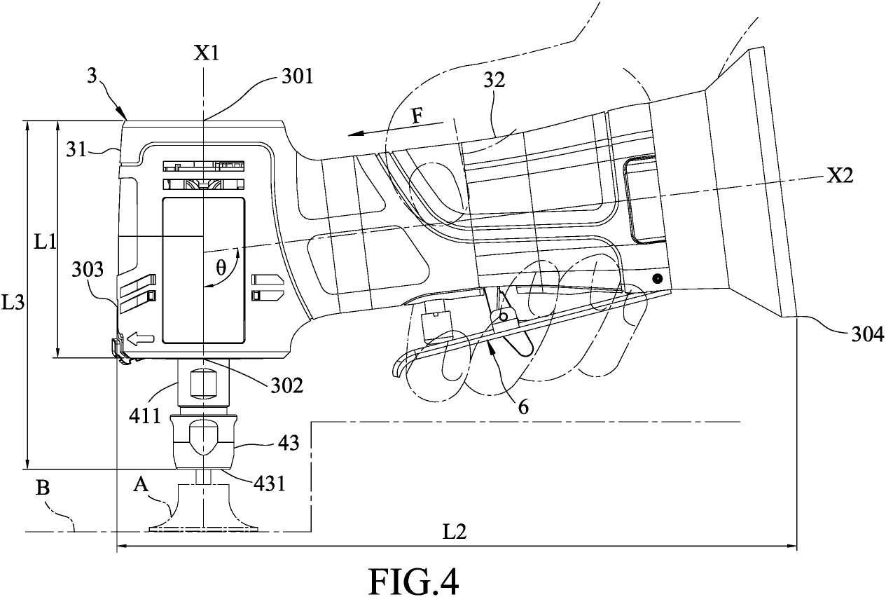

The working chuck 43 is mounted on the output section 411 of the rotating shaft 41 to be directly driven by the rotating shaft 41, and is adapted for connection with a grinding head (A) as shown in FIG. 4. The grinding head (A) is used for grinding an object (B).

The working chuck 43 has an end face 431 that is distal from the first side 301 along the first axis (X1). The end face 431 is spaced apart from the first side 301 by a third distance (L3) along the first axis (X1); the third distance (L3) is less than 110 mm, preferably being between 108 mm and 109 mm.

The battery unit 5 is mounted on the grip part 32 of the casing structure 3, and is adapted for powering the drive unit 4.

The trigger unit 6 is mounted on the grip part 32, and when it is operated, activates the brushless motor 42 to directly drive the rotating shaft 41. A projection of the trigger unit 6 onto the plane perpendicular to the first axis (X1) has a length greater than one-third of the second distance (L2).

Referring to FIGS. 3 and 4, when holding the grip part 32 of the portable grinding tool, the user can operate the trigger unit 6 to switch on the brushless motor 42 so that the rotating shaft 41 can bring the grinding head (A) to rotate for grinding the object (B).

It should be noted that in the present disclosure, the third distance (L3) is shortened by the design of the rotating shaft 41 directly driving the working chuck 43, making the drive unit 4 closer to a working surface and improving the user’s control. Additionally, the grip part 32 can be kept sufficiently distant from the working surface when the grinding head (A) is in contact with the working surface because the angle (θ) between the grip part 32 and the output section 411 ranges between 95 and 135 degrees. This allows more maneuvering space for the user’s hand while holding the grip part 32.

According to the above description, the advantages of the aforementioned embodiment can be summarized as follows:

1. The user’s hand holding the grip part 32 is farther away from the working surface especially when the portable grinding tool of the present disclosure is operated in a scenario with a stepped surface because of the obtuse angle formed between the grip part 32 and the output section 411 of the rotating shaft 41. This facilitates the operation of the trigger unit 6 and prevents the trigger unit 6 from accidentally bumping into surrounding objects.

2. Due to the aforementioned obtuse angle formed between the grip part 32 and the output section 411, when the grip part 32 is held by the user and when the user exerts a force (F) on the grip part 32 during the grinding operation as shown by an arrow in FIG. 4, because the force (F) can react against the torque of a reaction force acting on the casing structure 3, the user can grip the grip part 32 with ease in an effort-saving manner. In addition, the overall design allows the portable grinding tool to have a center of gravity near the main body part 31, which improves user comfort during operation.

3. By virtue of the design of the first distance (L1), the second distance (L2), and the third distance (L3), in combination with the aforementioned obtuse angle, the portable grinding tool can be held in an ergonomic way, and user comfort during operation can thus be further promoted.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A portable grinding tool, comprising:
a casing structure that includes a main body part defining a first axis, and a grip part extending from said main body part along a second axis; and
a drive unit that is mounted on said main body part, and that includes a rotating shaft and a brushless motor driving said rotating shaft to output rotational kinetic energy, said rotating shaft having an output section that extends along said first axis and passes through said main body part, said output section and said grip part cooperating to define an angle therebetween, said angle ranging between 95 and 135 degrees.

2. The portable grinding tool as claimed in claim 1, wherein said main body part has a first side, and a second side distal from said first side along said first axis, said first side being spaced apart from said second side along said first axis by a first distance of less than 75 mm.

3. The portable grinding tool as claimed in claim 2, wherein said main body part further has a third side, and said grip part has a fourth side distal from said third side along said second axis, projections of said third side and said fourth side onto a plane perpendicular to said first axis being spaced apart from each other by a second distance that ranges between 200 mm and 240 mm.

4. The portable grinding tool as claimed in claim 3, wherein said drive unit further includes a working chuck that is mounted on said output section of said rotating shaft and that is adapted for connection with a grinding head, said working chuck having an end face distal from said first side along said first axis and spaced apart from said first side along said first axis by a third distance of less than 110 mm .

5. The portable grinding tool as claimed in claim 4, wherein said second distance is either 230 mm or 208 mm, and said third distance ranges between 108 mm and 109 mm.

6. The portable grinding tool as claimed in claim 3, further comprising a trigger unit mounted on said grip part, and adapted for triggering rotation of said rotating shaft, a projection of said trigger unit onto the plane perpendicular to the first axis having a length greater than one-third of said second distance.

7. The portable grinding tool as claimed in claim 1, further comprising a battery unit mounted on said grip part of said casing structure, and adapted for powering said drive unit.

8. The portable grinding tool as claimed in claim 1, wherein said angle ranges between 95 and 100 degrees.

9. A casing structure of a portable grinding tool that includes a rotating shaft adapted for outputting rotational kinetic energy and extending along a first axis, said casing structure comprises:
a main body part configured for rotatable mounting of said rotating shaft thereon; and
a grip part extending from said main body part along a second axis at an angle ranging between 95 and 135 degrees with respect to said first axis.

10. The casing structure as claimed in claim 9, wherein said angle ranges between 95 and 100 degrees.

11. The casing structure as claimed in claim 9, wherein said main body part has a first side and a second side distal from said first side along said first axis, said first side being spaced apart from said second side along said first axis by a first distance of less than 75 mm.

12. The casing structure as claimed in claim 11, wherein said main body part further has a third side, and said grip part has a fourth side distal from said third side along said second axis, projections of said third side and said fourth side onto a plane perpendicular to said first axis being spaced apart from each other by a second distance that ranges between 200 mm and 240 mm.

13. The casing structure as claimed in claim 11, the portable grinding tool further including a working chuck that is mounted on said rotating shaft and that has an end face distal from said first side along said first axis, wherein said first side of said main body part is spaced apart from said end face of said working chuck along said first axis by a third distance of less than 110 mm.
